(19) United States
(12) Patent Application Publication
(10) Pub. No.: US 2006/0149973 A1
(43) Pub. Date: Jul. 6, 2006

(54) Digital information copying management apparatus

(75) Inventors: Hitoshi Koseki, Kakegawa-shi (JP); Kazunobu Fujiwara, Hamamatsu-shi (JP); Tetsuya Matsuyama, Hamamatsu-shi (JP); Sadayuki Narusawa, Hamamatsu-shi (JP)

Correspondence Address: PILLSBURY WINTHROP SHAW PITTMAN LLP, P.O BOX 10500, McLean, VA, 22102, US

(73) Assignee: Yamaha Corporation, Hamamatsu-shi (JP)

(21) Appl. No.: 11/290,349

(22) Filed: Nov. 30, 2005

(30) Foreign Application Priority Data
Nov. 30, 2004 (JP) P2004-347150

(51) Int. Cl. G06F 12/14; H04L 9/32; G06F 11/30

(52) U.S. Cl. 713/193

(57) ABSTRACT

A digital information copying management apparatus includes a data storage unit that is arranged to store data, a data processing unit that controls writing and reading of the data to and from the data storage unit, a bus that connects the data storage unit and the data processing unit for transmitting data having plural bits in parallel, and a logic circuit unit that is provided between the data storage unit and the data processing unit, and that inverts at least one bit data of the data that is transferred in the bus in parallel.

### BACKGROUND OF THE INVENTION

The present invention relates to an electronic apparatus equipped with a data storage device that is suitable for storage of data or the like whose copying needs to be restricted, such as video data or musical data.

In recent years, the capacity of storage devices such as the HDD (hard disk drive) has increased greatly. HDDs having a sufficient capacity for storage of a large amount of content data such as video data and musical data have come to, for example, be marketed and AV apparatus incorporating an HDD have been developed.

Such AV apparatus can store, in the built-in HDD, content data of video, music, etc acquired through legitimate purchase, for example. To reproduce video or music in response to, for example, a user's instruction, such AV apparatus can read designated content data from the HDD and perform reproduction processing for the video or music on the bases of the read-out data.

Incidentally, where content data are stored in the built-in HDD of an AV apparatus in the above manner, the content data stored in the HDD may be copied illegally by the following method. First, the HDD in which content data are stored is removed from the AV apparatus. Then, the HDD is connected to a personal computer or the like and the content data stored in the HDD are read out and copied to another storage device.

Among the methods for preventing illegal copying including removal of the HDD are a method of recording encrypted content data into the HDD of an AV apparatus and a method of using a special file system (other than general-purpose file systems such as FAT and NTFS) as a file system for managing files in the HDD.

However, in the method of recording encrypted content data, the apparatus configuration becomes complicated as exemplified by the fact that an arrangement (hardware or software) for encrypting (or decrypting in the case of reading) content data is necessary. Further, because of an encryption (or decryption) processing time, the content data recording (or reading) rate as a capability of the AV apparatus is lowered.

In the method of managing files in the HDD using a special file system rather than a general-purpose one, it is necessary to newly develop a special file system. In addition, where a special file system is used, it is impossible to manage the HDD using a general-purpose file system.

In view of the above, an electronic apparatus has been developed which prevents data copying in the following manner (e.g., JP-A-2003-5875). When content data are recorded in units of a bit string, the content data are recorded while the wiring form is changed on a bit string basis and the wiring form changing pattern is controlled.

However, where the wiring form is merely changed as in the electronic apparatus disclosed in JP-A-2003-5875, the wiring form changing pattern can be analyzed easily, leaving a risk that illegal copying is performed by using a decrypted pattern,

### SUMMARY OF THE INVENTION

The present invention has been made in the above circumstances, and an object of the invention is therefore to provide a digital information copying management apparatus which, though simple in structure, has a strong measure against illegal copying of data stored in a data storage device without lowering the recording rate or reading rate of the data storage device even in the case where the data are managed by using a general-purpose file system.

(1) A digital information copying management apparatus, comprising:

a data storage unit that is arranged to store data;

a data processing unit that controls writing and reading of the data to and from the data storage unit;

a bus that connects the data storage unit and the data processing unit for transmitting data having plural bits in parallel; and

a logic circuit unit that is provided between the data storage unit and the data processing unit, and that inverts at least one bit data of the data that is transferred in the bus in parallel.

In this invention, when data transmitted from the data processing unit are recorded into the data storage unit, bit data are inverted by the logic circuit unit which is connected to at least part of the lines of the bus corresponding to the respective bits and resulting data are recorded into the data storage unit. Therefore, even if the data storage unit is removed from the apparatus and connected to another apparatus and the data recorded in the data storage unit are read out, readout data cannot be used like the original data and hence illegal copying or the like can be prevented.

(2) The digital information copying management apparatus according to (1), further comprising a circuit control unit that controls an inverting pattern of the logic circuit unit,

wherein the logic circuit unit inverts the data transferred in the bus based on the inverting pattern.

In this invention, when certain data transmitted from the data processing unit are recorded into the data storage unit, bit data are inverted according to a certain pattern by the logic circuit unit which is connected to at least part of the lines of the bus corresponding to the respective bits and the circuit control unit for controlling the inversion/non-inversion pattern of the logic circuit unit and resulting data are recorded into the data storage unit. Therefore, even if the data storage unit is removed from the digital information copying management apparatus and connected to another apparatus and the data recorded in the data storage unit are read out, read-out data cannot be used like the original data and hence illegal copying or the like can be prevented.

(3) The digital information copying management apparatus according to (2), wherein the circuit control unit changes the inverting pattern to another inverting pattern for each piece of predetermined unit data in the transferred data when the data processing unit writes the data to the data storage unit;

wherein the circuit control unit sets the same inverting pattern as is used at the time of writing to the logic circuit unit when the data processing unit reads the data from the data storage unit; and

wherein the logic circuit unit inverts the data read from the data storage unit based on the same inverting pattern.

In this invention, when certain data transmitted from the data processing unit are recorded into the data storage unit, the inverting pattern is changed on a prescribed unit data basis. For example, the prescribed unit data are data of a single piece of music in the case of musical data. Changing the inverting pattern for each piece of unit data (for each piece of music) makes it possible to prevent illegal copying more reliably.

(4) The digital information copying management apparatus according to (3), further comprising a pattern information storage unit that is arranged to store pattern information indicating the inverting patterns that are set to the logic circuit unit at the time of writing of the data,

wherein the circuit control unit sets the same inverting pattern as is used at the time of writing to the logic circuit unit when the data processing unit reads the data from the data storage unit based on the pattern information stored in the pattern information storage unit.

In this invention, when certain data transmitted from the data processing unit are recorded into the data storage unit, identification information for identification of each piece of unit data is stored in a built-in memory or the like. For example, in the case of musical data, the prescribed unit data are data of a single piece of music and the identification information includes the name of a piece of music. When the data recorded in the data storage unit are read out the pieces of pattern information are referred to and the musical data are read out according to the same inverting patterns as were used when the musical data were recorded into the data storage unit

(5) The digital information copying management apparatus according to (3), further comprising a header information processing unit that writes, in the data storage unit, as header information for each piece of the unit data, pattern information indicating the inverting patterns that are set to the logic circuit unit at the time of writing of the data,
wherein the circuit control unit sets the same inverting pattern as is used at the time of writing to the logic circuit unit when the data processing unit reads the data from the data storage unit based on the header information.

In this invention, when certain data transmitted from the data processing unit are recorded into the data storage unit, identification information for identification of each piece of unit data is recorded into the data storage unit as header information. Further, encrypted by using the unique apparatus ID, each piece of header information cannot be decrypted even if the data storage unit is removed from the apparatus and connected to another apparatus as long as an ID of the latter apparatus is used. Illegal copying can thus be prevented more reliably. For example, the unique apparatus ID may be a serial number or a MAC (media access control) address of each apparatus.

(6) The digital information copying management apparatus according to (3), wherein the another inverting pattern includes a non-inverted state of all bit data of the data.

(7) The digital information copying management apparatus according to (4), wherein the pattern information storage unit is provided separately from the data storage unit.

(8) The digital information copying management apparatus according to (5), wherein the header information processing unit encrypts the pattern information based on a unique apparatus ID before writing the pattern information as the header information in the data storage unit; and

wherein the circuit control unit decrypts the encrypted header information based on the unique apparatus ID and sets the same inverting pattern to the logic circuit unit.

As described above, the invention can provide a strong measure against illegal copying of data stored in a data storage unit without lowering the recording rate or reading rate of the data storage unit even in the case where data management is performed by using a general-purpose file system or the like.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a block diagram showing the configuration of an audio apparatus according to a first embodiment of the present invention;

FIG. 2 schematically shows a configuration for transmitting data between a CPU, an HDD controller, a logic circuit section, and an HDD;

FIG. 3 illustrates how bit data are recorded into the HDD;

FIG. 4 schematically shows a configuration for transmitting data between a CPU, an HDD controller, and an HDD in a related electronic apparatus;

FIG. 5 illustrates how bit data are recorded into the HDD in the related electronic apparatus;

FIG. 6 schematically shows a configuration for transmitting data between the HDD of the audio apparatus and a CPU and an HDD controller of another apparatus;

FIG. 7 schematically shows a configuration for transmitting data between a CPU, an HDD controller, a logic circuit section, and an HDD in a modification;

FIG. 8 schematically shows a configuration for transmitting data between a CPU, an HDD controller, a logic circuit section, and an HDD in another modification;

FIG. 9 is a block diagram showing the configuration of an audio apparatus according to a second embodiment of the invention;

FIG. 10 schematically shows a configuration for transmitting data between a CPU, an HDD controller, a logic circuit section, and an HDD in the audio apparatus according to the second embodiment;

FIG. 11 illustrates the inside of the logic circuit section in which a selector is provided for each bit;

FIG. 12 schematically shows a configuration for transmitting data between a CPU, an HDD controller, a logic circuit section, and an HDD in a modification of the audio apparatus according to the second embodiment;

FIG. 13 schematically shows a configuration for transmitting data between a CPU, an HDD controller, a logic circuit section, and an HDD In another modification of the audio apparatus according to the second embodiment; and

FIG. 14 schematically shows a configuration for transmitting data between a CPU, an HDD controller, a logic circuit section, and an HDD in an audio apparatus according to a third embodiment.

### DETAILED DESCRIPTION OF THE PREFERRED EMBODIMENTS

Audio apparatus according to embodiments of the present invention will be hereinafter described in detail with reference to the drawings.

### Embodiment 1

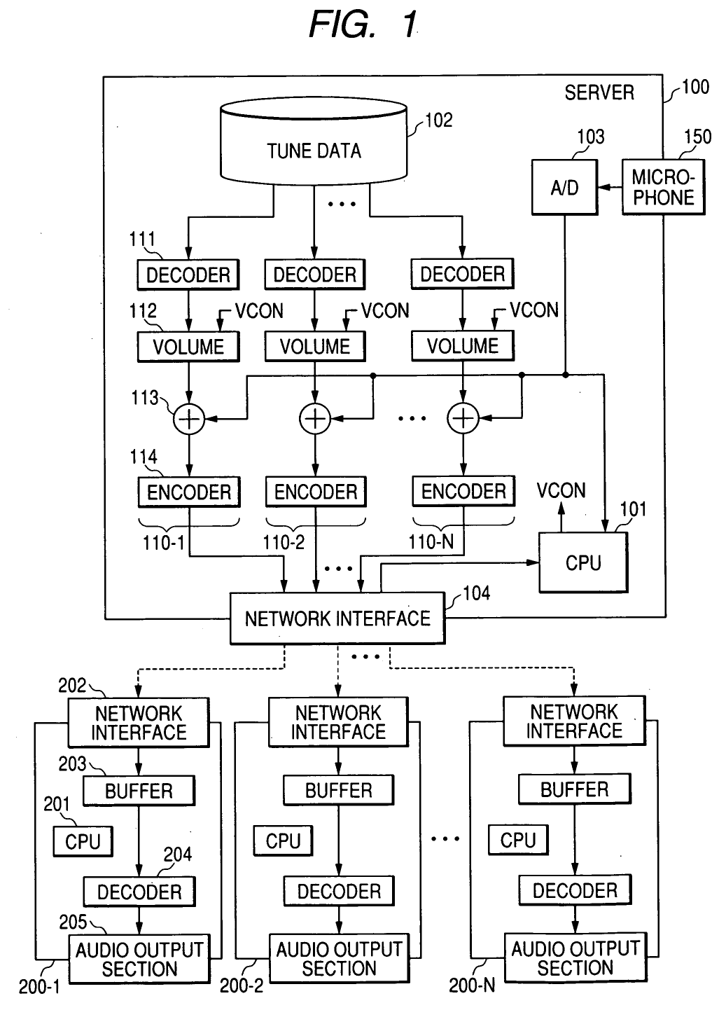

FIG. 1 is a block diagram showing the entire configuration of an audio apparatus 100 according to a first embodiment of the invention. As shown in FIG. 1, the audio apparatus 100 includes a CPU 10, a ROM 11, a RAM 12, a CD-ROM drive 13, an HDD controller 14, a communication interface 15, a DSP (digital signal processor) 16, and a signal output control section 17 all of which are connected to each other via a bus 18. In this embodiment, the bus 18 has a 16-bit width and 16-bit data can be transmitted in parallel between components connected to the bus 18. The width of the bus 18 is not limited to 16 bits and may be 32 bits or the like.

The CPU 10 controls the individual sections of the audio apparatus 100. Various programs and data for the DSP 16, firmware programs for controlling the basic operation of the audio apparatus 100, various control programs, etc. are stored in the ROM 11. The CPU 10 performs various kinds of control processing by reading out programs etc. stored in the ROM 11. The RAM 12 functions as a working area by storing various kinds of data temporarily.

The CD-ROM drive 13 reads digital data recorded on a CD into the audio apparatus 100. The HDD controller 14 is connected to the bus 18 and is also connected to an HDD 19 via a bus 22a, a logic circuit section 110, and a bus 22b. Under the control of the CPU 10, the HDD controller 14 controls recording of data into the HDD 19 or reading of data stored in the HDD 19.

The logic circuit section 110, which is provided between the buses 22a and 22b, inverts individual bit data (i.e., data of respective bits).

The communication interface 15 is an interface for exchanging data with external apparatus. For example, data can be exchanged with various external devices and apparatus such as drive devices, audio apparatus, and personal computers via the communication interface 15. Further, the audio apparatus 100 can exchange data, via the communication interface 15, with apparatus that are connected to communication networks such as the internet and LANs (local area networks).

In the audio apparatus 100, audio data for reproduction of music that are read out by the CD-ROM drive 13 and audio data that are acquired from an external apparatus via the communication interface 15 can be stored in the HDD 19.

Under the control of the CPU 10, the DSP 16 reads out the programs and data stored in the ROM 11 and performs various kinds of processing such as addition of effects on audio data that are read from the HDD 19, for example.

The signal output control section 17 outputs an audio signal to and on which effects have been added and other processing has been performed by the DSP 16 as mentioned above to an amplifier 20, a signal output terminal (not shown), or the like. The amplifier 20 amplifies the audio signal supplied from the signal output control section 17 and outputs the amplified audio signal to speakers 21. The speakers 21 emit sound according to the audio signal supplied from the amplifier 20.

The audio apparatus 100 according to the embodiment can acquire audio data by the CD-ROM drive 13's reading the contents of a musical CD that has been acquired legitimately by a user through purchase and can also acquire audio data by a legitimate act of, for example, buying the audio data from an external apparatus (e.g., a server for a music delivery service) via the communication interface 15. Audio data that are acquired legitimately in these manners are stored in the HDD 19. Audio data stored in the HDD 19 can be read out and used for reproduction of music or audio data output.

As described above, the audio apparatus 100 is convenient for a user because audio data can be stored in the HDD 19 and read out for use. However, the audio apparatus 100 may be subjected to the following illegal conduct of some person. That is, the HDD 19 is removed from the audio apparatus 100 and connected to a personal computer or the like and then the audio data stored in the HDD 19 are read out and copied to another storage device or storage medium illegally. The audio apparatus 100 according to the embodiment has a configuration for preventing an event that the HDD 19 is removed and the data recorded therein are copied illegally. The configuration for preventing such illegal copying will be described below in detail.

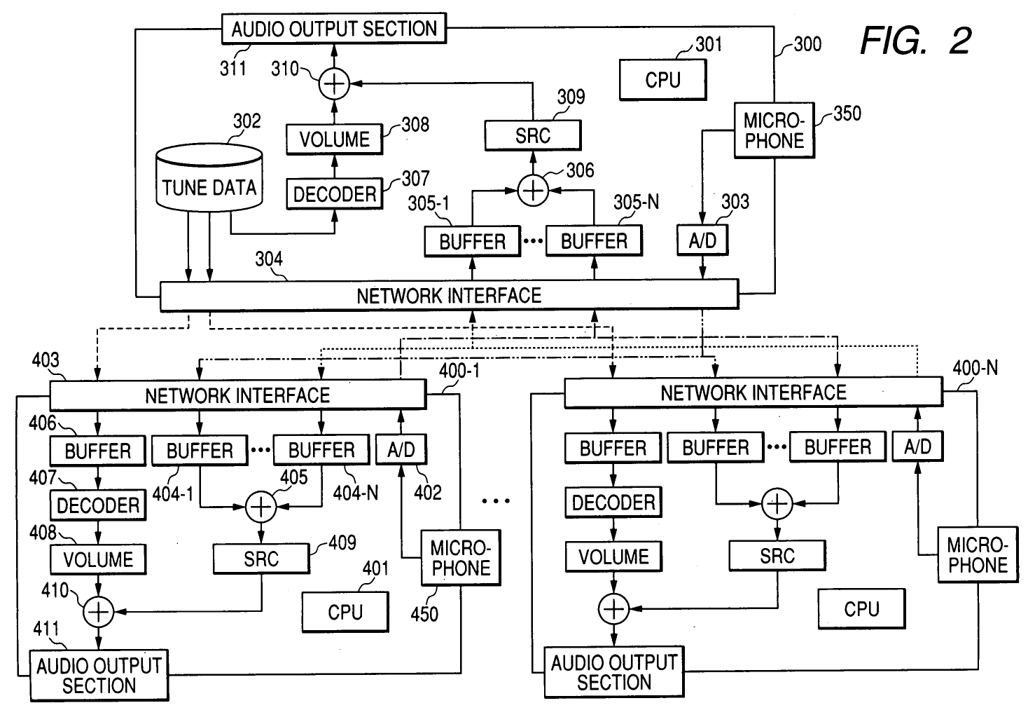

FIG. 2 shows a configuration for transmitting data between the CPU 10, the HDD controller 14, the logic circuit section 110, and the HDD 19 in the audio apparatus 100. As shown in FIG. 2, the CPU 10 and the HDD controller 14 are connected to each other via the bus 18 having a 16-bit width and the HDD controller 14 and the HDD 19 are connected to each other via the buses 22a and 22b each having a 16-bit width and the logic circuit section 110.

The bus 18 connecting the CPU 10 and the HDD controller 14 has an ordinary (i.e., common) bus structure. When data having a bit string D0, D1, D2, . . . , D15 are transmitted from the CPU 10 to the HDD controller 14, the HDD controller 14 receives the data as they are, that is, in such a manner that the bit string D0, D1, D2, . . . , D15 is maintained.

On the other hand, the logic circuit section 110, provided between the buses 22a and 22b which connect the CPU 10 and the HDD 19, transmits data so as to invert individual bit data. When data having a bit string D0, D1, D2, . . . , D15 are transmitted from the HDD controller 14 via the bus 22a, the HDD 19 receives the data and recognizes the data as having a bit string D0′, D1′, D2′, . . . , D15′ in which the bit data are inverted. That is, In the logic circuit section 110, inverter circuits 310 are provided between the buses 22a and 22b so that data are transmitted in such a manner that individual bit data are inverted (“1” to “0” or “0” to “1”).

The invention is not limited to the case that as described above data are transmitted to an HDD via a bus in the baseband domain. Where data go through a transmission line that transmits modulated data (e.g., USB line), the modulated data may be inverted. Examples in which a baseband modulation method is employed and bit data are inverted will be described below. In the case of such a modulation method as the PE (phase encoding) method, a modulation waveform may be inverted. Inverting a modulation waveform makes it possible to invert bit data according to the values of respective positions of the modulation waveform. In the case of the PE method, the bit data becomes “1” at each rise of the modulation waveform and becomes “0” at each fall of the modulation waveform. Where the modulation waveform is inverted, each rise of the modulation waveform turns to a fall and the bit data becomes “0” there. Likewise, each fall of the modulation waveform turns to a rise and the bit data becomes “1” there. In this manner, inverting a modulation waveform enables transmission of inverted bit data.

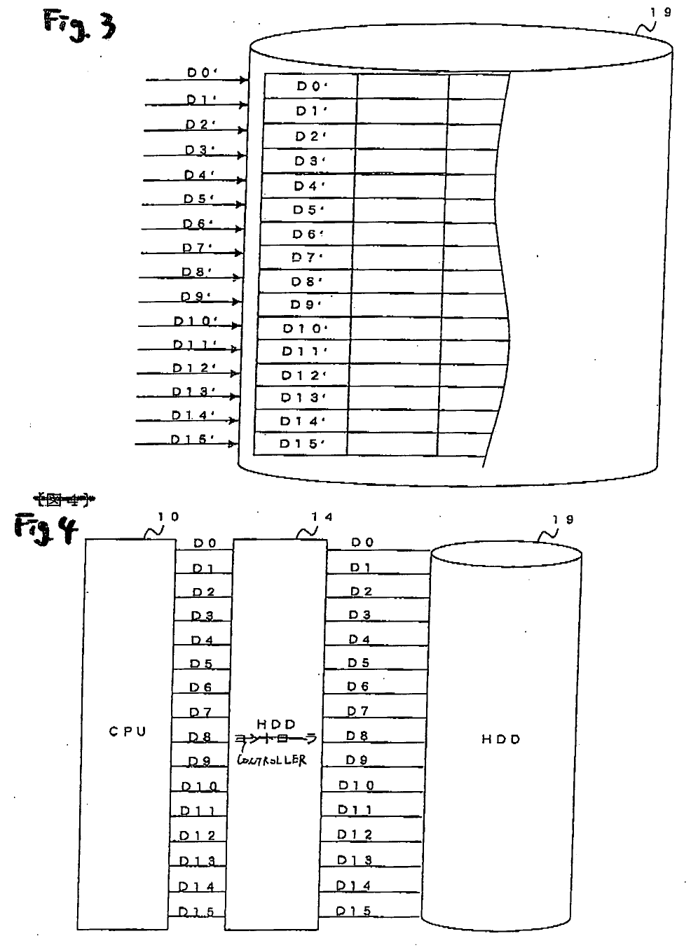

In the NRZI (non return to zero inverted) modulation, bit data “1” is represented by non-inversion of the output state (Hi or Lo) of a waveform at clock timing and bit data “0” is represented by a change (rise or fall) of the output state of the waveform at clock timing. In the case of this modulation method, bit data are inverted by inverting the bit data at clock timing when the output state of a waveform is not inverted and not inverting the bit data at clock timing when the output state of a waveform changes.

Where the HDD controller 14 and the HDD 19 are connected to each other by using the above-described logic circuit section 110, when data having a bit string D0, D1, D2, . . . , D15 are supplied from the CPU 10 to the HDD 19 via the HDD controller 14, bit data D0′ (e.g., “0”) is supplied to the HDD 19 instead of the bit data D0 (e.g. “1”) as shown in FIG. 3. Therefore, the inverted bit data D0′ is written to the HDD 19. Bit data D1′ (e.g., “1”) is supplied to the HDD 19 instead of the bit data D1 (e.g. “0”), and hence the inverted bit data D1′ is written to the HDD 19. In this manner, data having bit data obtained by inverting the bit data of data that should be recorded into the HDD 19 originally are written to the HDD 19.

As described above, data that are opposite to data that are recognized by the CPU 10 and the HDD controller 14 are recorded into the HDD 19. However, data (e.g., control commands for the CPU 10 and HDD controller 14's controlling the HDD 19 and control data such as status information) other than the recording data are also supplied to the HDD 19 after their bit data are inverted. Therefore, it is appropriate to modify the HDD 19 used in this embodiment in such a manner that the register bit definitions of control data of a built-in controller is set so as to be suitable for the bit data inversion. With this measure, even if the HDD 19 receives control data having bit data obtained by inverting the bit data of original control data as output from the HDD controller 14, the HDD 19 can handle the received control as if they were the original control data.

As described above, data (e.g., audio data) that are supplied from the CPU 10 are recorded into the HDD 19 as data whose bit data are different from the bit data of the original data as recognized by the CPU 10. To read out user-designated data that are recorded in the HDD 19 in such a manner that their bit data are changed, the CPU 10 instructs the built-in controller of the HDD 19 to read out the designated data. In the thus-instructed HDD 19, the built-in controller causes sequential output of bit data that are stored in a corresponding recording area. The HDD 19 outputs bit data D0′, D1′, D2′, . . . , D15′, for example, which are supplied to the CPU 10 via the bus 22b, the logic circuit section 110, the bus 22a, and the HDD controller 14. As shown in FIG. 2, the logic circuit section 110 of this embodiment also has inverter circuits 310 that invert bit data of the respective bits of data that are sent from the HDD 19. The logic circuit section 110 transmits data through these inverter circuits 310 at the time of data reading. Therefore, the bit string D0′, D1′, D2′, . . . , D15′ that is output from the HDD 19 is recognized by the HDD controller 14 as a bit-data-inverted bit string. That is, data recorded in the HDD 19 that have bit data obtained by inverting the bit data of original data are received by the HDD controller 14 as data having the same bit strings as the original data and the latter data are supplied to the CPU 10 via the bus 18. As a result, the CPU 10 can use data themselves read from the HDD 19 for music reproduction processing, for example, without the need for such processing as bit data inversion.

In FIG. 2, the line of each bit has two parallel inverter circuits 310 that are opposite in direction and data are transferred along different paths in data writing and data reading. However, the invention is not limited to this structure. The logic circuit section 110 may employ any structure as long as it enables bit data inversion in each of data writing and data reading. In the logic circuit section 110, switching between data writing and data reading can be made by, for example, control data such as a control command that is issued from the CPU 10 to control the HDD 19.

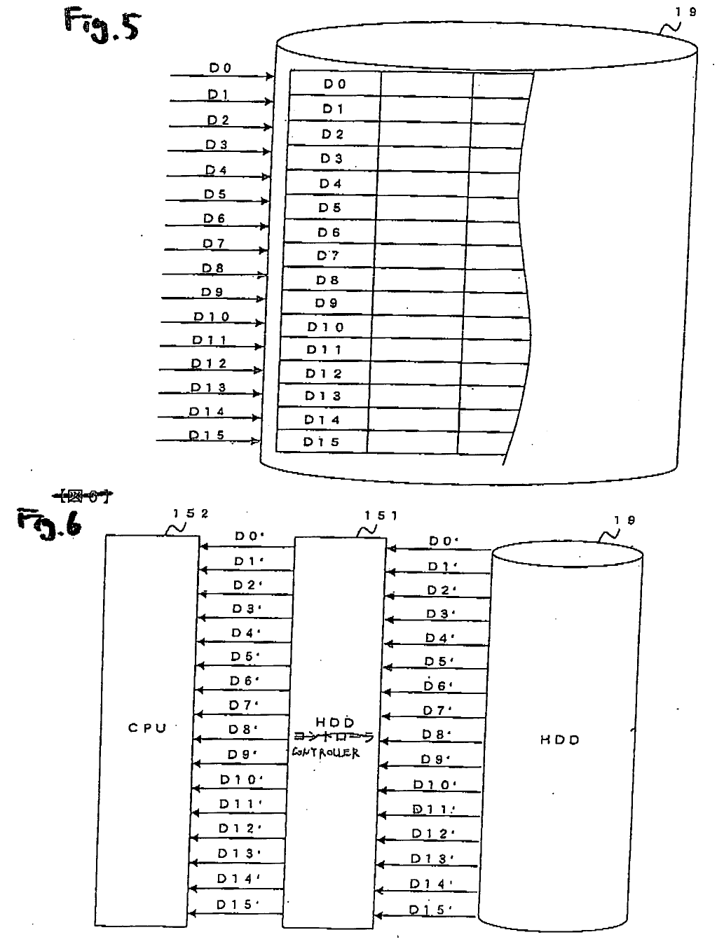

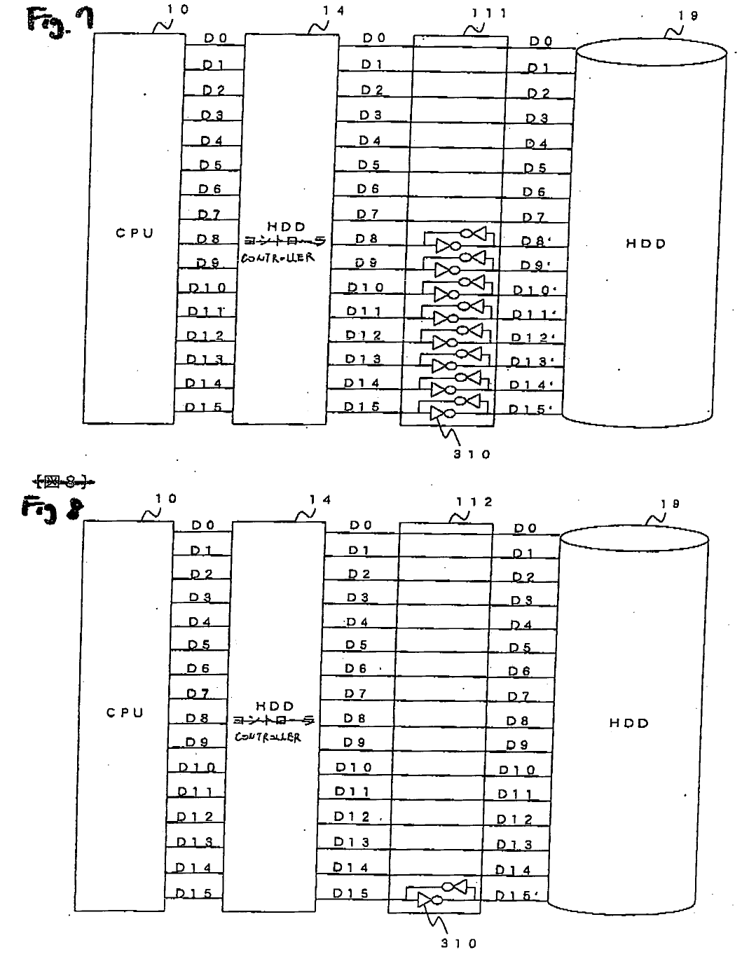

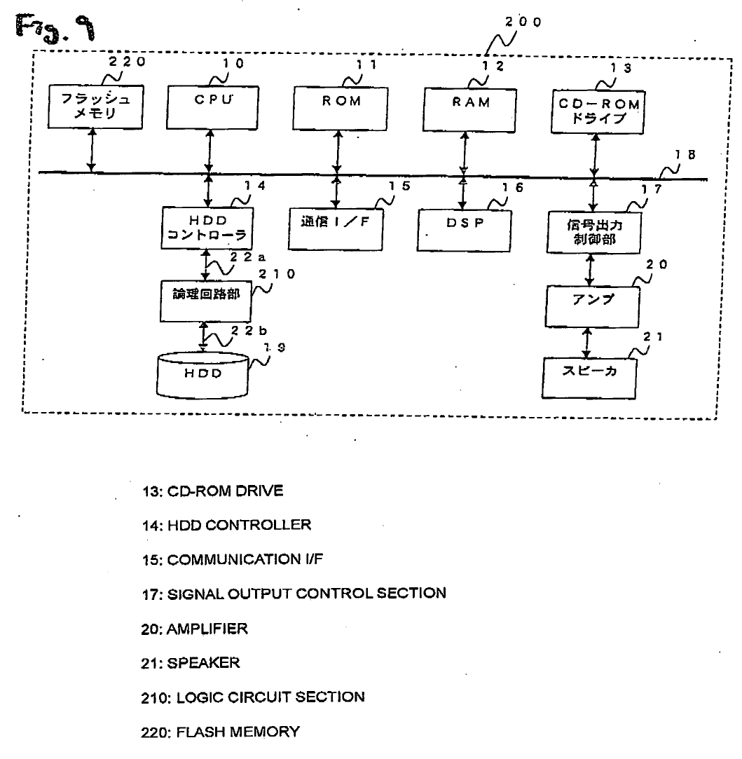

In contrast, where as shown in FIG. 4 the HDD 19 and the HDD controller 14 are connected to each other in an ordinary (i.e., common) connection form in which the logic circuit section 110 is not used, bit data D0, D1, D2, . . . , D15 as output from the CPU 10 are written to the HDD 19 as they are as shown in FIG. 5.

As described above, in the audio apparatus 100 according to the embodiment, unlike in the case of the ordinary (i.e., common) connection form, audio data, for example, that are acquired from the CD-ROM drive 13 or via the communication interface 15 are recorded into the HDD 19 as data whose bit data are different from the bit data of the original data. Therefore, even if only the HDD 19 is removed from the audio apparatus 100 and connected to another apparatus (e.g., personal computer), the data recorded in the HDD 19 can be prevented from being read out and copied illegally. More specifically, in the audio apparatus 100 according to the embodiment, as shown in FIG. 3, data having inverted bit data D0′, D1′, D2′, . . . , D15′ are recorded in the HDD 19 instead of original data having bit data D0, D1, D2, . . . , D15. Therefore, as shown in FIG. 6, if the HDD 19 is removed from the audio apparatus 100 and connected to an HDD controller 151 of another apparatus 150, the bit data D0′, D1′, D2′, . . . , D15′ are output from the HDD 19 to the HDD controller 151. The HDD controller 151 outputs the bit data D0′, D1′, D2′, . . . , D15′ which are different to the original bit data to a CPU 152 or the like. Therefore, the data recorded in the HDD 19 cannot be utilized by the apparatus 150 and hence can be prevented from being copied or subjected to like processing.

As described above, the audio apparatus 100 according to the embodiment can prevent illegal copying or the like of the data recorded in the HDD 19 by a simple configuration that the logic circuit section 110 for inverting bit data is provided between the HDD controller 14 and the HDD 19. In this configuration, the CPU 10 and the HDD controller 14 need not perform data conversion processing such as data encryption. Therefore, the rate of writing or reading data to or from the HDD 19 is not lowered by such processing as encryption (or decryption). Further, in this embodiment, it is not necessary to use a special file system for data management of the HDD 19; illegal copying of data can be prevented even in the case where the file management of the HDD 19 is performed by using a general-purpose file system.

In the above-described first embodiment, the logic circuit section 110 inverts bit data of all the bits that are transmitted between the HDD controller 14 and the HDD 19. However, the invention is not limited to such a case; it is sufficient for the logic circuit section 110 to invert bit data of at least part of the bits. For example, as shown in FIG. 7, another logic circuit section 111 may be used which inverts part of original bit data D0, D1, D2, . . . , D15 (so recognized by the HDD controller 14) so that the data are recognized by (and recorded into) the HDD 19 as having bit data D0, D1, D2, . . . , D7, D8′, D9′, D10′, . . . , D15′. In the logic circuit section 111, inverter circuits 310 are inserted in the lines for transmitting the lower-bit bit data D8, D9, D10, . . . , D15, respectively. Alternatively, as shown in FIG. 8, still another logic circuit section 112 may be used which inverts only the lowest-bit bit data of original bit data D0, D1, D2, . . . , D15 (so recognized by the HDD controller 14) so that the data are recognized by (and recorded into) the HDD 19 as having bit data D0, D1, . . . , D7, D8, D9, D10, . . . , D15′. In the logic circuit section 112, an inverter circuit 310 is inserted only in the line for transmitting the lowest-bit bit data 15. The invention is not limited to these examples in which bit data of a half of the bits or bit data of only the lowest bit is inverted; bit data of original data may be inverted in any form as long as bit data of at least part of the bits are recognized as different from the bit data of the original data.

### Embodiment 2

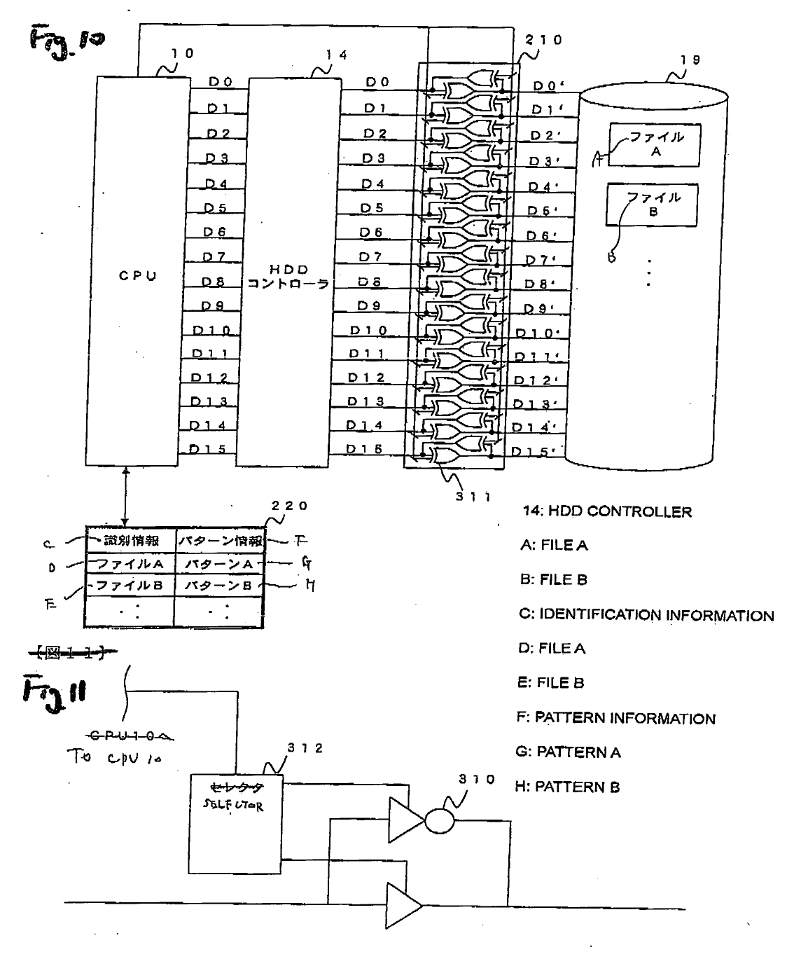

FIG. 9 shows the entire configuration of an audio apparatus 200 according to a second embodiment of the invention. In the second embodiment, components that are common to the first embodiment are given the same reference symbols as in the first embodiment and will not be described.

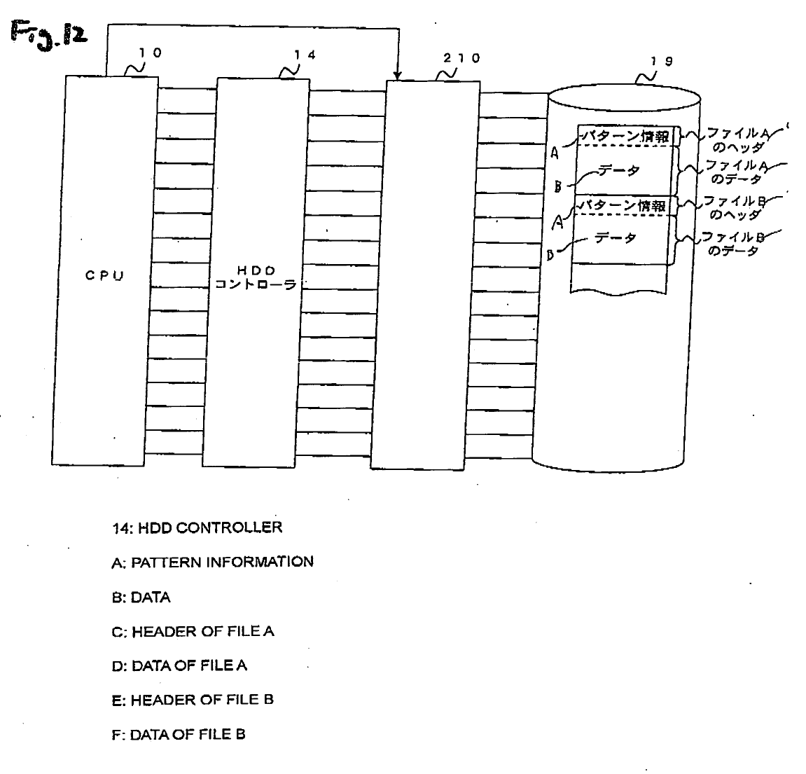

As shown in FIG. 9, the audio apparatus 200 according to the second embodiment is different from the audio apparatus 100 according to the first embodiment in that a flash memory 220 is connected to the bus 18 and a logic circuit section 210 is provided between the buses 22a and 22b in place of the logic circuit section 110. In the audio apparatus 200 according to the second embodiment, as in the case of the first embodiment, under the control of the CPU 10, data (e.g., audio data for reproduction of music) acquired from the CD-ROM drive 13 or via the communication interface 15 can be stored in the HDD 19 in such a manner as to be prevented from being copied illegally or subjected to like processing. A configuration relating to data transmission between the HDD 19 and the CPU 10 will be described below with reference to FIGS. 9 and 10.

In the audio apparatus 200 according to the second embodiment, the CPU 10 and the HDD controller 14 are connected to each other by the bus 18 having a 16-bit width and the HDD controller 14 and the HDD 19 are connected to each other by the buses 22a and 22b each having a 16-bit width and the logic circuit section 210 which is provided between the buses 22a and 22b.

The logic circuit section 210 is the same as the logic circuit section 110 of the first embodiment in being a circuit for inverting the bit data of data being transmitted, but is different from the latter in that the bit inverting pattern can be varied according to a control of the CPU 10. In the inverting-pattern-variable logic circuit section 210, as shown in FIG. 10, an exclusive OR circuit 311 is provided for each bit. Having two inputs, each exclusive OR circuit 311 outputs bit data “0” when the two inputs have the same bit data and outputs bit data “1” when the two inputs have different bit data. Therefore, each exclusive OR circuit 311 can invert bit data when necessary according to a control of the CPU 10 (i.e., according to a control signal that is output from the CPU 10). Instead of using the exclusive OR circuit 311, as shown in FIG. 11, a selector 312 which enables selection between bit data inversion and non-inversion may be provided for each bit so that bit data can be inverted when necessary according to a control of the CPU 10.

In the second embodiment as in the case of the first embodiment, data are transferred along different paths in data writing and data reading. However, the invention is not limited to this structure. The logic circuit section 210 may employ any structure as long as bit data of prescribed bits can be inverted according to a control of the CPU 10 (i.e., control signals from the CPU 10) and, for example, control data such as a control command in each of data writing and data reading.

The flash memory 220 (a pattern information storing unit) has an area in which identification information for identification of prescribed unit data (assumed below as a file of a single piece of musical data) stored in the HDD 19 and pattern information indicating an inverting pattern that was employed in the logic circuit section 210 in storing the file identified by the identification information are stored so as to be correlated with each other. The flash memory 220 also has an area for storing a unique ID of each audio apparatus 200. Although in this embodiment the flash memory 220 is used as a storage medium for storing identification information and pattern information, the invention is not limited to such a case. The storage medium for this purpose may be any rewritable storage medium other than the HDD 19, such as another HDD, an EEPROM, or a floppy disk.

In the second embodiment, the CPU 10 performs the following processing in recording or reading data into or from the HDD 19 by running data recording/reading programs stored in the ROM 11.

First, to record, into the HDD 19, an audio data file for reproduction of a certain single piece of music acquired from the CD-ROM drive 13 or via the communication interface 15, the CPU 10 writes identification information for identification of this file to an identification information storage area of the flash memory 220 and also writes information indicating an inverting pattern that is employed in the logic circuit section 210 in recording this file to a pattern information recording area, corresponding to the identification information storage area, of the flash memory 220. The inverting pattern employed in the logic circuit section 210 in recording the file may be selected, by using a random number, for example, from plural inverting patterns prepared by the CPU 10 in advance. The plural inverting patterns prepared in advance may be various patterns such as a pattern that bit data of all the bits are inverted (first embodiment), a pattern that bit data are inverted so as to be recognized as D0, D1, D2, . . . , D7, D8′, D9′, D10′, . . . , D15′ by the HDD 19 (see FIG. 7), a pattern that bit data are inverted so as to be recognized as D0, D1, D2, . . . , D15′ by the HDD 19 (see FIG. 8), and a pattern that bit data are inverted so as to be recognized as randomly inverted data by the HDD 19.

After writing the identification information and the pattern information to the flash memory 220, the CPU 10 outputs a control signal to the logic circuit section 210 to set the logic circuit section 210 so that an identification information recording inverting pattern stored in the ROM 11, for example, in advance will take effect and outputs only bit strings representing the identification information of the file to be recorded to the HDD 19 via the HDD controller 14, the bus 222, the logic circuit section 210, and the bus 22b. As a result, bit strings representing the identification information whose bit data have been controlled by the identification information recording inverting pattern that is set in the logic circuit section 210 are recorded into the HDD 19. The identification information recording inverting pattern may be an arbitrary pattern such as a pattern that bit data are not inverted at all (i.e., the pattern of the common connection form) or a pattern that all bit data are inverted.

After recording the identification information into the HDD 19, the CPU 10 outputs a control signal to the logic circuit section 210 to set the logic circuit section 210 so that the inverting pattern indicated by the inverting pattern information stored in the pattern information storage area of the flash memory 220 will take effect. After setting the inverting pattern of the logic circuit section 210 in this manner, the CPU 10 outputs the data of the file concerned to the HDD 19 via the HDD controller 14. For example, if the inverting pattern that is set in the logic circuit section 210 is such as to invert all bit data (first embodiment; see FIG. 10), data that are output from the CPU 10 and have bit data D0, D1, D2, . . . , D15 are recognized by (and recorded into) the HDD 19 as data having fully inverted bit data D0′, D1′, D2′, . . . , D15′ (first embodiment; see FIG. 3).

On the other hand, to read out data recorded in the HDD 19, first, the CPU 10 controls the HDD 19 via the HDD controller 14 so that the identification information of a file that has been designated by a user as a reading file will be read out. Such control data for instructing the HDD 19 to perform reading are supplied to the HDD 19 in the following manner. The CPU 10 outputs a control signal to the logic circuit section 210 to set the logic circuit section 210 so that a control data transmission inverting pattern prepared in advance will take effect. In a state that the control data transmission inverting pattern is set in the logic circuit section 210, the CPU 10 transmits bit strings of the control data to the HDD 19. As a result, bit strings representing the control data whose bit data have been controlled by the control data transmission inverting pattern that is set in the logic circuit section 210 are supplied to the HDD 19. The control data transmission inverting pattern may be an arbitrary pattern such as a pattern that bit data are not inverted at all (i.e., the pattern of the common connection form) or a pattern that all bit data are inverted. Where bit data are changed according to this pattern, it is necessary that the register bit definition be set so as to correspond to inverted bit data so that the built-in controller of the HDD 19 can recognize a control instruction indicated by data having changed bit strings.

After transmitting the control data to the HDD 19, the CPU 10 outputs a control signal to the logic circuit section 210 to set the logic circuit section 210 so that the identification information recording inverting pattern will take effect As a result, the bit strings of the data indicating the identification information for identification of the designated file are read from the HDD 19 and supplied to the CPU 10 as the original data. For example, even if the identification information recording inverting pattern that was used at the time of recording is such as to invert bit data of all the bits, the data having the original bit strings are supplied to the CPU 10 by reading the data by setting the same patter in the logic circuit section 210. The CPU 10 can recognize the identification information by referring to the read-out data.

By referring to the contents of the flash memory 220, the CPU 10 determines the pattern information that is correlated with the identification information that has been read from the HDD 19 and understood by the CPU 10 itself. The CPU 10 outputs a control signal to the logic circuit section 210 to set the logic circuit section 210 so that the inverting pattern indicated by the determined pattern information will take effect. After this inverting pattern is set in the logic circuit section 210, a bit string of data of the designated file is supplied from the HDD 19 to the CPU 10 via the bus 22b, the logic circuit section 210, the bus 22a, and the HDD controller 14. In this manner, the data of the designated file are supplied to the CPU 10 as data having entirely the same bit strings as the original bit strings by reading the data from the HDD 19 by setting, in the logic circuit section 210, the inverting pattern indicated by the determined pattern information, that is, the same inverting pattern as used at the time of recording of the data. For example, where the inverting pattern indicated by the determined pattern information is such as to invert bit data of all the bits, data having the original bit data are supplied to the CPU 10 by reading the data by setting the same pattern.

As described above, in the audio apparatus 200 according to the second embodiment, the inverting pattern of the logic circuit section 210 can be set for each file to be recorded into the HDD 19. That is, how to change bit data of each bit string of data to be recorded into the HDD 19 can be set on a file-by-file basis. For example, inverting patterns may be such that a certain file is recorded into the HDD 19 as data whose bit data are a fully inverted version of the bit data of original data and another file is recorded into the HDD 19 as data in which only the lowest-bit bit data is an inverted version of the corresponding bit data of the original data.

With the above measure, even if only the HDD 19 is removed from the audio apparatus 200 and connected to another apparatus (e.g., personal computer), the data recorded in the HDD 19 can reliably be prevented from being read out and copied illegally. For example, if how bit data of each bit string of data recorded in the HDD 19 are different from those of original data (e.g., bit data of all the bits are inverted) should become known for a certain file, the original data of this file can be restored by inverting the bit data of the data recorded in the HDD 19 according to the pattern thus found. However, original data of a file that is recorded in the HDD 19 as data in which only the lowest-bit bit data is inverted cannot be obtained even if inversion processing is performed according to the inverting pattern found (e.g., bit data of all the bits are inverted). As is understood from the above discussion, illegal copying can be prevented more reliably than in the first embodiment by making it possible to set, on a file-by-file basis, how to change bit data of each bit string of data to be recorded into the HDD 19.

As described above, the audio apparatus 200 according to the second embodiment can prevent illegal copying or the like of the data recorded in the HDD 19 by simple processing of controlling the inverting pattern of the logic circuit section 210. Since the CPU 10 and the HDD controller 14 need not perform such processing as encryption of data to be recorded into the HDD 19, the rate of writing or reading data to or from the HDD 19 is not lowered by encryption (or decryption) processing. Further, as in the case of the first embodiment, illegal copying of data can be prevented even in the case where the file management of the HDD 19 is performed by using a general-purpose file system.

In the audio apparatus 200 according to the second embodiment, information indicating what inverting patterns were used in recording respective files is recorded in the flash memory 220 rather than in the HDD 19 for recording of data. Since the information indicating the inverting patterns is not recorded in the HDD 19, it is difficult to find the inverting patterns that were used in recording the respective files when it is attempted to, for example, illegally copy the data by removing the HDD 19 from the audio apparatus 200. Illegal data copying can thus be prevented more reliably.

Although in the second embodiment the inverting pattern that is used for recording and reading is changed for each data file of a single piece of music, the invention is not limited to such a case. For example, the inverting pattern may be changed for each file group including data files of plural pieces of music (e.g., in units of a file group including data files of all pieces of music of a musical album).

The invention is not limited to the above-described embodiments and various modifications are possible as exemplified below.

[Modification 1]

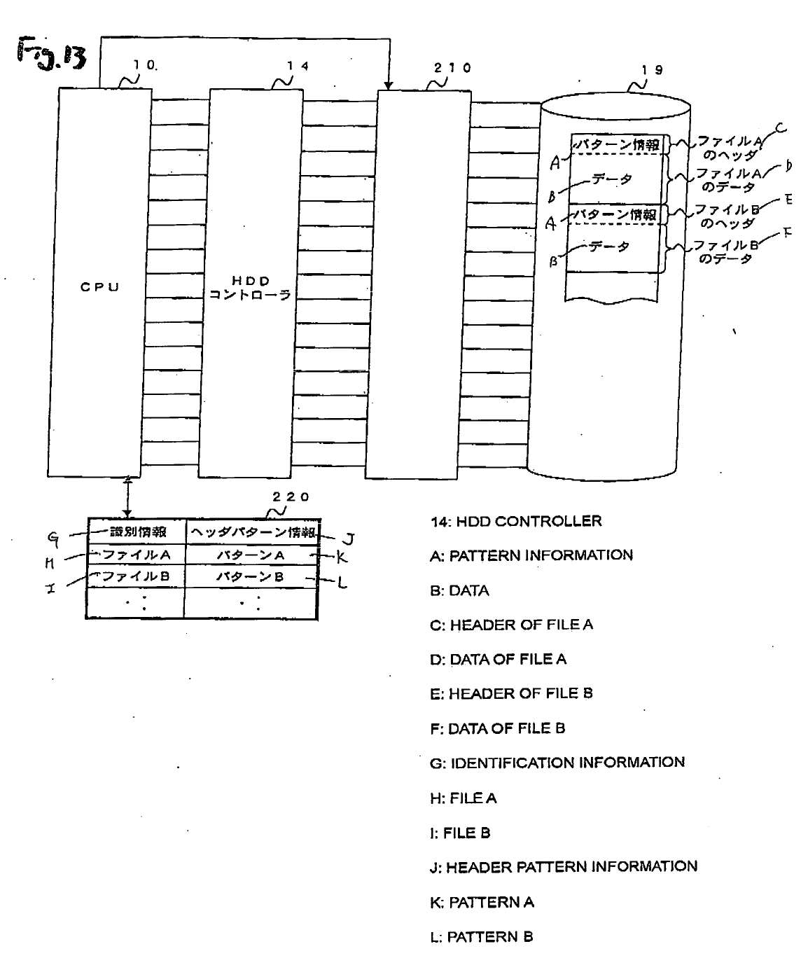

The above-described second embodiment employs the flash memory 220 in which pieces of identification information for identification of respective files and pieces of pattern information are stored so as to be correlated with each other. However, as shown in FIG. 12, pattern information indicating what inverting pattern was used for a data transfer may be contained in a header portion of a file stored in the HDD 19 (i.e., the flash memory 220 is not used for storage of the pattern information).

As shown in FIG. 12, in this modification, when the CPU 10 records the data of a certain file (assumed to be file A) into the HDD 19 via the HDD controller 14 and the logic circuit section 210, the CPU 10 determines an inverting pattern to be used for transfer of file A using a random number, for example, and provides file A with a header for pattern identification (i.e., a dedicated header to be used only inside the apparatus 200 is provided in addition to an existing header). And the CPU 10 writes, in the header, information indicating the thus-determined inverting pattern to be set in the logic circuit section 210 in transferring the data of file A to the HDD 19. In doing so, the CPU 10 encrypts the header using the unique ID of the audio apparatus 200 stored in the flash memory 200. The unique ID may be a serial number, a MAC address, or the like of the audio apparatus 200. The CPU 10 outputs a control signal to the logic circuit section 210 so that a preset header portion transfer inverting pattern is set in the logic circuit section 210. In this state (i.e., the preset header portion transfer inverting pattern is set in the logic circuit section 210), the CPU 10 transfers only the header portion of file A to the HDD 19 via the HDD controller 14 and the logic circuit section 210, as a result of which only the header portion containing the pattern information is recorded into the HDD 19. Then, the CPU 10 outputs a control signal to the logic circuit section 210 so that the inverting pattern indicated by the pattern information that was written in the header portion is set in the logic circuit section 210. Then, the CPU 10 transfers the data portion of file A to the HDD 19 via the HDD controller 14 and the logic circuit section 210. As a result, file A as a combination of the header portion and the data portion is recorded into the HDD 19. The data portion is recorded as data having bit data obtained through a change according to the inverting pattern indicated by the pattern information.

Next, a description will be made of processing for reading out file A that was recorded into the HDD 19 by transferring it using the different inverting patterns for the header portion and the data portion. To read out file A in response to a user's instruction, first the CPU 10 outputs a control signal to the logic circuit section 210 so that the header portion transfer inverting pattern is set in the logic circuit section 210. In this state (i.e., the header portion transfer inverting pattern is set in the logic circuit section 210), the CPU 10 reads out only the header portion of file A from the HDD 19 via the logic circuit section 210 and the HDD controller 14. Further, the CPU 10 decrypts the header portion using the unique ID stored in the flash memory 220. That is, the header portion is read from the HDD 19 by using the same inverting pattern as was used in transferring it to the HDD 19. Therefore, the CPU 10 can recognize the pattern information contained in the readout header portion.

After recognizing the pattern information contained in the header portion, the CPU 10 outputs a control signal to the logic circuit section 210 so that the inverting pattern indicated by the pattern information is set in the logic circuit section 210. Then, the CPU 10 reads the data portion of file A from the HDD 19 via the logic circuit section 210 and the HDD controller 14 using the same inverting pattern as was used in transferring it to the HDD 19. Therefore, the CPU 10 can use the read-out data portion as ordinary data without the need for performing such processing as decryption on it. After reading out the data portion and recognizing that the last data of the data portion has been read out (e.g., EOF (end of file) data has been detected), the CPU 10 outputs a control signal to the logic circuit section 210 so that the header portion transfer inverting pattern is set in the logic circuit section 210, to prepare for reading of another file.

[Modification 2]

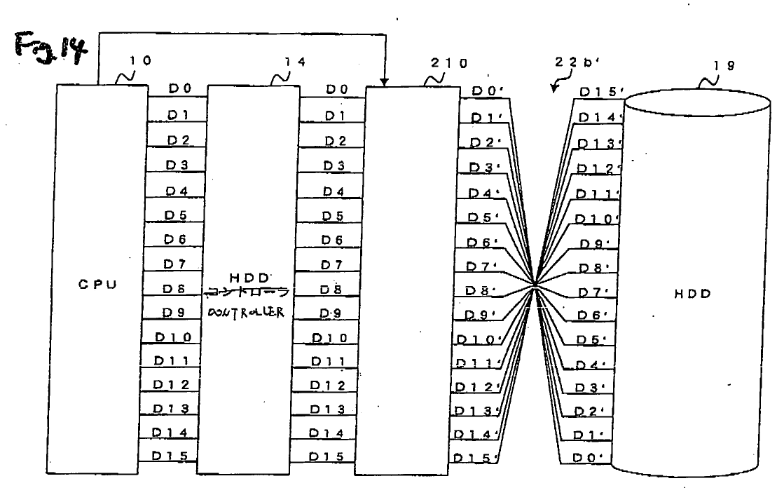

In the above modification, a header portion containing pattern information is transferred by using a certain fixed header portion transfer inverting pattern. In contrast, as shown in FIG. 13, the inverting pattern that is used for transfer of a header portion may be changed on a file-by-file basis.

In this modification, as shown in FIG. 13, when the CPU 10 records the data of a certain file (assumed to be file A) into the HDD 19 via the HDD controller 14 and the logic circuit section 210, the CPU 10 determines an inverting pattern to be used for transfer of file A using a random number, for example, and provides file A with a header for pattern identification. And the CPU 10 writes, in the header, information indicating the thus-determined inverting pattern. In doing so, the CPU 10 encrypts the header using the unique ID of the audio apparatus 200 stored in the flash memory 200. Further, the CPU 10 determines an inverting pattern to be used for transfer of the header portion of file A using a random number, for example, and stores header pattern information indicating the determined inverting pattern and identification information for identification of file A in another storage device (e.g., flash memory 220) In such a manner that they are correlated with each other. The CPU 10 outputs a control signal to the logic circuit section 210 so that the determined header portion transfer inverting pattern is set in the logic circuit section 210. In this state (i.e., the determined header portion transfer inverting pattern is set in the logic circuit section 210), the CPU 10 transfers only the header portion of file A to the HDD 19 via the HDD controller 14 and the logic circuit section 210, as a result of which only the header portion containing the pattern information is recorded into the HDD 19. Then, the CPU 10 outputs a control signal to the logic circuit section 210 so that the inverting pattern indicated by the pattern information that was written in the header portion is set in the logic circuit section 210. Then, the CPU 10 transfers the data portion of file A to the HDD 19 via the HDD controller 14 and the logic circuit section 210. As a result, file A as a combination of the header portion and the data portion is recorded into the HDD 19.

Next, a description will be made of processing for reading out file A that is recorded into the HDD 19 by transferring it using the different inverting patterns for the header portion and the data portion. To read out file A in response to a user's instruction or the like, the CPU 10 outputs a control signal to the logic circuit section 210 so that the inverting pattern indicated by the header pattern information that is correlated with the identification information of file A stored in the flash memory 220 is set in the logic circuit section 210. In this state (i.e., the inverting pattern indicated by the header pattern information is set in the logic circuit section 210), the CPU 10 reads out only the header portion of file A from the HDD 19 via the logic circuit section 210 and the HDD controller 14. Then, the CPU 10 decrypts the header portion using the unique ID of the apparatus 200. The CPU 10 can thus recognize the pattern information contained in the read-out header portion. After recognizing the pattern information contained in the header portion, the CPU 10 outputs a control signal to the logic circuit section 210 so that the inverting pattern indicated by the pattern information is set in the logic circuit section 210. Then, the CPU 10 reads the data portion of file A from the HDD 19 via the logic circuit section 210 and the HDD controller 14 using the same inverting pattern as was used in transferring it to the HDD 19. Therefore, the CPU 10 can use the read-out data portion as ordinary data without the need for performing such processing as decryption on it.

### Embodiment 3

FIG. 14 schematically shows a configuration for transmitting data between the CPU, the HDD controller, the logic circuit section, and the HDD in an audio apparatus according to a third embodiment. As shown in FIG. 14, this embodiment is the same as the second embodiment in that the CPU 10 is connected to the HDD 19 via the HDD controller 14 and the logic circuit section 210. However, the lines are crossed in a bus 22b′ which connects the logic circuit section 210 and the HDD 19. When data that are arranged in order of D0′, D1′, D2′, . . . , D15′ are transmitted from the logic circuit section 210 to the HDD 19, the HDD 19 recognize the received data as being arranged in order of D15′, D14′, S13′, . . . , D0′. In this manner, data supplied from the CPU 10 are recorded into the HDD 19 as data whose bit data are different from the bit data of the original data as recognized by the CPU 10 and, in addition, are arranged in different order than the bit data of the original data.

As described above, in the audio apparatus according to this embodiment, unlike in an apparatus having an ordinary (i.e., common) wiring form, data supplied from the CPU 10 are recorded into the HDD 19 as data whose bit data are different from the bit data of the original data and, in addition, are arranged in different order than the bit data of the original data. Therefore, even if the HDD 19 is removed from the audio apparatus and connected to another apparatus, the data recorded in the HDD 19 can be prevented even more reliably from being read and copied illegally.

Although in the above-described third embodiment, the wiring form is employed that reverses the order of the bit data of data transmitted between the logic circuit section 210 and the HDD 19, the invention is not limited to such a case. Any wiring form may be employed as long as it enables a data transfer that changes the order of the bit data of data between the HDD controller 14 and the HDD 19.

A wiring circuit or the like whose wiring form can be varied according to a control of the CPU 10 may be provided between the HDD controller 14 or between the logic circuit section 210 and the HDD 19. For example, the wiring circuit may be a circuit element whose structure can be defined by programming, such as a PLD (programmable logic device) or an FPGA (field programmable gate array).

As described above, the invention can provide a strong measure to prevent illegal copying of data stored in a data storage device without lowering its capabilities such as the recording rate and the reading rate even in the case where data management is performed by using a general-purpose file system or the like, though the measure is implemented by a simple structure such as additional inverter circuits.

Although the above-described first, second, and third embodiments are directed to the case that the invention is applied to the audio apparatus, the invention can also be applied to other electronic apparatus such as video reproduction/recording apparatus incorporating a storage device for storing various kinds of data such as musical data and video data that should be prevented from being copied illegally.

Further, although the above-described first, second, and third embodiments are directed to the case that data are transmitted to the HDD, the invention can also be applied to a case that data are transmitted to another type of storage device such as a flash memory or an MO disc.

Although the invention has been illustrated and described for the particular preferred embodiments, it is apparent to a person skilled in the art that various changes and modifications can be made on the basis of the teachings of the invention. It is apparent that such changes and modifications are within the spirit, scope, and intention of the invention as defined by the appended claims.

The present application is based on Japan Patent Application No. 2004-347150 filed on Nov. 30, 2005, the contents of which are incorporated herein for reference,

What is claimed is:

1. A digital information copying management apparatus, comprising:
a data storage unit that is arranged to store data;
a data processing unit that controls writing and reading of the data to and from the data storage unit;
a bus that connects the data storage unit and the data processing unit for transmitting data having plural bits in parallel; and
a logic circuit unit that is provided between the date storage unit and the data processing unit, and that inverts at least one bit data of the data that is transferred in the bus in parallel.

2. The digital information copying management apparatus according to claim 1, further comprising a circuit control unit that controls an inverting pattern of the logic circuit unit,
wherein the logic circuit unit inverts the data transferred in the bus based on the inverting pattern.

3. The digital information copying management apparatus according to claim 2, wherein the circuit control unit changes the inverting pattern to another inverting pattern for each piece of predetermined unit data in the transferred data when the data processing unit writes the data to the data storage unit;
wherein the circuit control unit sets the same inverting pattern as is used at the time of writing to the logic circuit unit when the data processing unit reads the data from the data storage unit; and
wherein the logic circuit unit inverts the data read from the data storage unit based on the same inverting pattern.

4. The digital information copying management apparatus according to claim 3, further comprising a pattern information storage unit that is arranged to store pattern information indicating the inverting patterns that are set to the logic circuit unit at the time of writing of the data,
wherein the circuit control unit sets the same inverting pattern as is used at the time of writing to the logic circuit unit when the data processing unit reads the data from the data storage unit based on the pattern information stored in the pattern information storage unit.

5. The digital information copying management apparatus according to claim 3, further comprising a header information processing unit that writes, in the data storage unit, as header information for each piece of the unit data, pattern information indicating the inverting patterns that are set to the logic circuit unit at the time of writing of the data,
wherein the circuit control unit sets the same inverting pattern as is used at the time of writing to the logic circuit unit when the data processing unit reads the data from the data storage unit based on the header information.

6. The digital information copying management apparatus according to claim 3, wherein the another inverting pattern includes a non-inverted state of all bit data of the data.

7. The digital information copying management apparatus according to claim 4, wherein the pattern information storage unit is provided separately from the data storage unit.

8. The digital information copying management apparatus according to claim 5, wherein the header information processing unit encrypts the pattern information based on a unique apparatus ID before writing the pattern information as the header information in the data storage unit; and
wherein the circuit control unit decrypts the encrypted header information based on the unique apparatus ID and sets the same inverting pattern to the logic circuit unit.
